(19) United States
(12) Patent Application Publication
(10) Pub. No.: US 2010/0077706 A1
(43) Pub. Date: Apr. 1, 2010

(54) MACHINE FOR THE APPLICATION OF THREADED CAPS ON CONTAINERS

(76) Inventor: Sergio Cirio, Canelli (Asti) (IT)

Correspondence Address: NIXON & VANDERHYE, PC, 901 NORTH GLEBE ROAD, 11TH FLOOR, ARLINGTON, VA, 22203, US

(21) Appl. No.: 12/434,967

(22) Filed: May 4, 2009

(30) Foreign Application Priority Data
Sep. 30, 2008 (IT) TO2008A0000712

(51) Int. Cl. B67B 3/20

(52) U.S. Cl. 53/490

(57) ABSTRACT

A machine for application of threaded caps on containers (C), comprising:
a bottom stationary base (12);
a first shaft (16) that extends upwards from the bottom stationary base (12), the first shaft (16) being rotatable with respect to the base (12) about a vertical axis (18) and being fixed in a vertical direction with respect to the base (12);
a rotary structure (24) fixed to a top end of the first shaft (16) and designed to convey the containers to be capped (C) along a circular path;
a second shaft (36) that extends upwards from the stationary base (12), the second shaft (36) being rotationally fixed with respect to the base (12) and being adjustable in a vertical direction with respect to the stationary base (12), wherein the second shaft (36) extends upwards beyond the top end of the first shaft (16), and wherein a top supporting flange (42) is fixed to the top end of the second shaft (36), the top supporting flange (42) bearing a drum cam (54);
a plurality of screwing heads (58) carried by the rotary structure (24), each screwing head (58) comprising a vertically mobile support (59) that engages said drum cam (54) and a spindle (60) carried in a rotatable way by the respective vertically mobile support (59), each spindle (60) bearing at its bottom end an assembly for gripping the caps (80) provided with a movement of screwing; and
an adjustment device (82), designed to adjust the vertical position of the second shaft (36) with respect to the stationary base (12).

### BACKGROUND OF THE INVENTION

The present invention relates to a machine for the application of threaded caps on containers, such as, for example, bottles or the like.

Machines for the application of threaded caps typically comprise a plurality of screwing heads arranged according to a carousel configuration. The containers to be closed are moved along a circular path in alignment with the screwing heads. Each screwing head has a spindle bearing a member for gripping the caps, which is axially mobile along a screwing axis and rotatable about said axis in synchronism with the axial movement for transmitting to the member for gripping the caps a movement of screwing. A solution widely used for transmitting the vertical movement to the spindles of the screwing heads envisages a stationary drum cam engaged by cam-follower members of the screwing heads.

In machines of this type there is the need to adjust the position of the screwing heads with respect to a plane of sliding of the containers. This adjustment has the purpose of varying the point in which the cap comes up to the containers. It is performed in the step of setting-up of the machine, and it is necessary to resort to this type of adjustment when the characteristics of the caps and/or of the containers vary.

In the known solutions, the structure that enables adjustment of the vertical position of the screwing heads with respect to the plane of sliding of the bottles is usually complex and costly.

### SUMMARY OF THE INVENTION

The object of the present invention is to provide a machine simpler and more economically advantageous than machines of a known type, in particular as regards the structure that enables the aforesaid adjustment to be made.

According to the present invention, said object is achieved by a machine for application of threaded caps on containers, comprising:

a bottom stationary base;

a first shaft that extends upwards from the bottom stationary base, the first shaft being rotatable with respect to the base about a vertical axis and being axially fixed in a vertical direction with respect to the base;

a rotary structure fixed to a top end of the first shaft and designed to convey the containers to be capped along a circular path;

a second shaft, which extends upwards from the stationary base, the second shaft being rotationally fixed with respect to the base and being adjustable in a vertical direction with respect to the stationary base, wherein the second shaft extends upwards beyond the top end of the first shaft;

a top supporting plate fixed to the top end of the second shaft bearing a drum cam;

a plurality of screwing heads carried by the rotary structure, each screwing head comprising a vertically mobile support that engages said drum cam and a spindle carried in a rotatable way by the respective vertically mobile support, each spindle bearing at its bottom end an assembly for gripping the caps provided with a movement of screwing; and

an adjustment device, designed to adjust the vertical position of the second shaft with respect to the stationary base.

### DESCRIPTION OF THE DRAWINGS

The present invention will now be described in detail with reference to the attached drawings, which are provided purely by way of non-limiting example and in which:

FIG. 1 is an axial cross section of a machine according to the present invention;

FIG. 2 is an axial cross section of the part indicated by the arrow II of FIG. 1;

FIG. 3 is a front view of the part indicated by the arrow III in FIG. 1;

FIG. 4 is an axial cross section of the part illustrated in FIG. 3; and

FIG. 5 is a cross section corresponding to FIG. 2 and illustrating a variant of the present invention.

### DESCRIPTION OF THE PREFERRED EMBODIMENTS

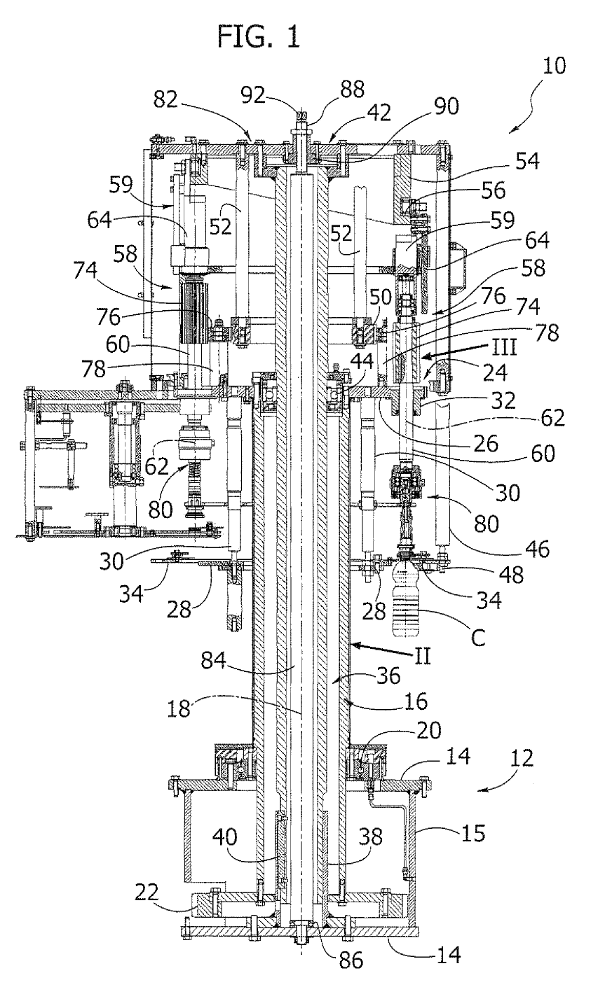

With reference to FIG. 1, designated by 10 is a machine for the application of threaded caps on containers C, such as, for example, bottles or the like. The machine 10 comprises a bottom stationary base 12, including two parallel horizontal plates 14 connected to one another by a side wall 15.

The base 12 bears a first shaft 16, which extends upwards from the stationary base 12. The shaft 16 is hollow and is carried by the stationary base 12 in a rotatable way about a vertical axis 18 by means of a first bearing assembly 20 carried by the top horizontal plate 14 of the base 12. The bottom end of the first shaft 16 extends within the base 12 and is fixed to an input gear 22 actuated by a motor assembly (not illustrated), either directly or via a cascade of gears. The first shaft 16 is rotatable with respect to the base 12 about the axis 18 and is fixed with respect to the base 12 in a vertical direction.

The machine 10 comprises a rotary structure 24, comprising a top rotary plate 26 and a bottom rotary plate 28. The rotary plates 26, 28 are both fixed with respect to the first shaft 16. The top rotary plate 26 is fixed directly to the top end of the first shaft 16, whilst the bottom rotary plate 28 is fixed to the top rotary plate 26 by means of a plurality of vertical columns 30. The top rotary plate 26 bears a plurality of bushings 32 with vertical axis, which are arranged radially with respect to the axis of rotation 18. The bottom rotary plate 28 faces a fixed guide 34. The bottom rotary plate 28 and the fixed guide 34 co-operate with one another for supporting the containers C to be capped, as illustrated in FIG. 1. The bottom rotary plate 28 in operation conveys the containers C along a circular path with the centre on the axis of rotation 18. The fixed guide 34 defines a plane of sliding of the containers C.

The machine 10 comprises a second shaft 36, which extends within the first shaft 16. Also the second shaft 36 is hollow and extends upwards from the stationary base 12. The second shaft 36 projects upwards beyond the top end of the first shaft 16. The second shaft 36 is rotationally fixed with respect to the base 12 and is adjustable with respect to the base 12 in a vertical direction along the axis 18. The bottom end of the second shaft 36 engages in a sliding way a cylindrical sleeve 38 fixed to the stationary base 12. An anti-rotation tab 40 is set between the sleeve 38 and the second shaft 36 to prevent rotation of the latter about the axis 18. The tab 40 does not prevent the movements of sliding of the second shaft 36 in the direction of the axis 18. A second bearing assembly 44 is set between the first shaft 16 and the second shaft 36 for supporting in rotation the first shaft 16 together with the first bearing assembly 20. The second bearing assembly 44 is mounted in such a way as not to hinder the movement of adjustment in height of the second shaft 36.

A top supporting plate 42 is fixed to the top end of the second shaft 36. The top supporting plate 42 is fixed with respect to the second shaft 36 following upon the movement of adjustment in a vertical direction of the latter. The top supporting plate 42 bears the stationary guide 34, which co-operates together with the rotary plate 28 for supporting the containers C to be capped. The stationary guide 34 is connected to the top supporting plate 42 by means of a first series of columns 46. The stationary guide 34 is connected to the bottom end of the columns 46 by means of threaded elements 48 that enable adjustment of the position in a vertical direction of the stationary guide 34 with respect to the bottom ends of the columns 46.

The top supporting plate 42 bears a gear 50 coaxial with respect to the shaft 16. The gear 50 is connected to the top supporting plate 42 by means of a second series of columns 52.

The top supporting plate 42 moreover bears a drum cam 54 having a cam groove 56. The drum cam 54 and the gear 50 are in a position fixed with respect to the top supporting plate 42 and are consequently mobile together with the latter following upon the movement of adjustment in a vertical direction of the second shaft 36.

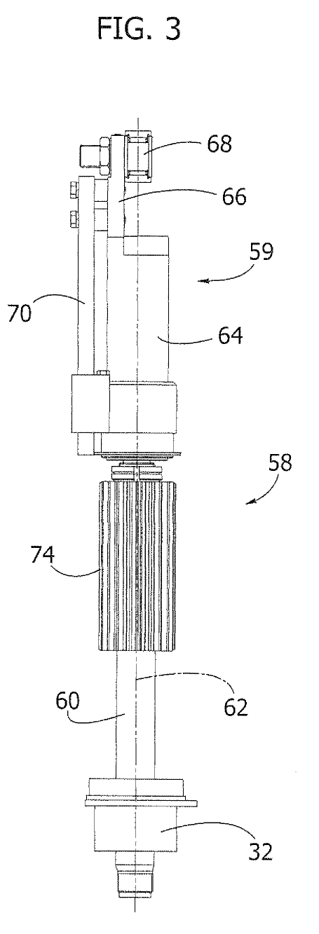

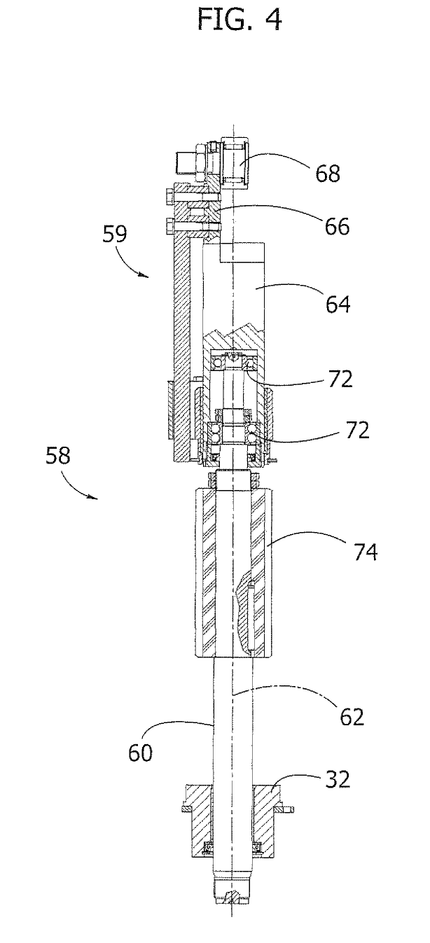

With reference to FIGS. 1, 3, and 4, the machine 10 comprises a plurality of screwing heads 58. Each screwing head 58 comprises a vertically mobile support 59 and a spindle 62 rotatable with respect to the vertically mobile support 59 about a vertical axis 62. The vertically mobile support 59 comprises a cylindrical body 64 having a top appendage 66 that bears a cam-follower member 68 that engages the cam groove 56 of the drum cam 54. An anti-rotation element 70 is provided to prevent rotation of the body 64 about the axis 62. The spindle 60 is connected in a rotatable way about the body 64 by means of bearings 72.

Each spindle 60 engages in a sliding way a respective bushing 32 carried by the top rotary plate 26 of the rotary structure 24. Above the top rotary plate 26 there is connected, by means of a plurality of columns (visible in part behind the screwing head on the left in FIG. 1), another plate; said plate bears a plurality of bushings, within which respective bodies 64 slide.

A gear 74 is fixed on the spindle 60 above the area that engages the bushing 32 in a sliding way. With reference to FIG. 1, the gear 74 of each spindle 60 engages a return gear 76 rotatably mounted on a pin 78 carried by the top rotary plate 26. Each return gear 76 in turn meshes with the fixed gear 50. The return gear 76 is present in the case where the direction of rotation of the rotary structure 24 and of the spindles 60 is discordant. The return gear 76 is not present in the case where said directions of rotation are concordant. In this case, the fixed gear 50 meshes directly with the gear 74.

The gear 50 can also be governed by an independent motor-reducer assembly (not illustrated) in order to vary the transmission ratio between the gear 50 and the spindles 60 as a function of the number of starts of the cap screw.

Each spindle 60 bears at its bottom end an assembly for gripping the caps 80, which includes a clutch assembly that in turn includes elastic elements.

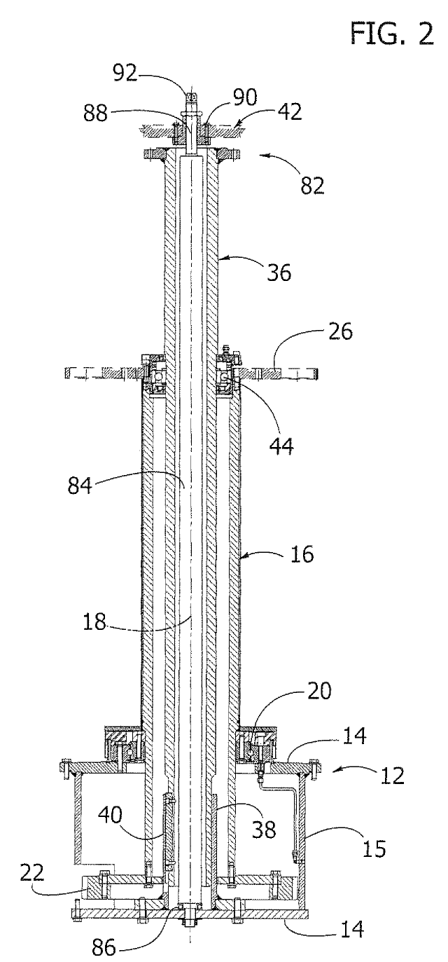

With reference to FIGS. 1 and 2, the machine 10 comprises a mechanism 82 for adjustment in height of the second shaft 36 and, consequently, of the top supporting plate 42. The adjustment mechanism 82 comprises a third shaft 84 coaxial with respect to the axis of rotation 18. The third shaft 84 extends within the second shaft 36. The third shaft 84 has a bottom end that engages in a rotatable way a hole formed in the bottom plate 14 of the stationary base 12. The third shaft 84 rests on the bottom plate 14 by means or a thrust bearing 86. The third shaft 84 is constrained in a vertical direction to the bottom plate 14 so that it is free to turn with respect to the bottom stationary base 12 but is fixed with respect to said base 12 in a vertical direction. A threaded stem 88 is formed at the top end of the third shaft 84. The threaded stem 88 engages a threaded bushing 90 fixed to the top supporting plate 42. The top end 92 of the threaded stem 88 is shaped for engagement by a spanner (not illustrated) by means of which it is possible to govern rotation of the third shaft 84 about the axis of rotation 18.

In operation, the first shaft 16 is set in rotation about the axis 18 via a motor assembly (not illustrated), either directly or via a cascade of gears, the motor assembly being associated to the input gear 22. During rotation of the shaft 36, the various screwing heads 58 carried by the rotary structure 24 move along a circular path centered on the axis of rotation 18. Following upon said movement, the supporting members 59 of each screwing head 58 move in a vertical direction from top downwards and vice versa as a result of the co-operation with the drum cam 54. Simultaneously, the spindle 60 of each screwing head 58 is driven in rotation about its own axis 62 as a result of the toothed connection of the gear 74 with the stationary gear 50. The gear 74 of each spindle 60 has a length in an axial direction such as to remain meshed with the return gear 76 in any axial position of the spindle. The vertical movement of the screwing heads is synchronised to the movement of rotation of the spindles 60 so that the assemblies 80 for gripping the screwing heads 58 are provided with a helical movement of screwing. During rotation about the axis 18, the rotary structure 24 picks up the containers C to be capped and conveys them along a circular path. Simultaneously, the screwing heads pick up the caps by means of the gripping assemblies 80 and carry out screwing of the caps on the containers C. After application of the caps, the containers C are unloaded on a conveyor (not illustrated).

An operation of preliminary setting-up of the machine 10 prior to starting a working cycle envisages adjustment of the distance between the assemblies for gripping the caps 80 and the plane of sliding of the containers C, defined by the bottom rotary plate 28 and by the associated fixed guide 34. This adjustment is performed by acting with a spanner on the actuation portion 92 of the third shaft 84. By turning the third shaft about the axis 18, the movement of the second shaft 36 and, consequently, of the top supporting plate 42 is governed in a vertical direction upwards or downwards. The movement of the plate 42 modifies the position in a vertical direction of the drum cam 54. Consequently, with this adjustment, the vertical position of the screwing heads 58 is modified. The movement of adjustment also modifies the position of the fixed guide 34, given that the latter is connected to the top supporting plate 42 by means of the columns 46. After adjustment of the position of the screwing heads 58 by acting on the actuation portion 92, it is necessary to re-align the fixed guide 34 to the rotary plate 28 by acting on the threaded members 48 that connect the fixed guide 34 to the columns 46.

This adjustment is necessary whenever the machine has to operate on containers and caps of a different type, to adapt the travel of screwing to the type of caps and containers. The movement of adjustment in a vertical direction of the top supporting plate 42 also enables variation of the load of the elastic elements of the gripping assemblies 80 that apply the axial force on the caps during the movement of screwing.

The structure of the machine 10 according to the present invention is particularly simple and economically advantageous, in particular as regards the adjustment mechanism 82.

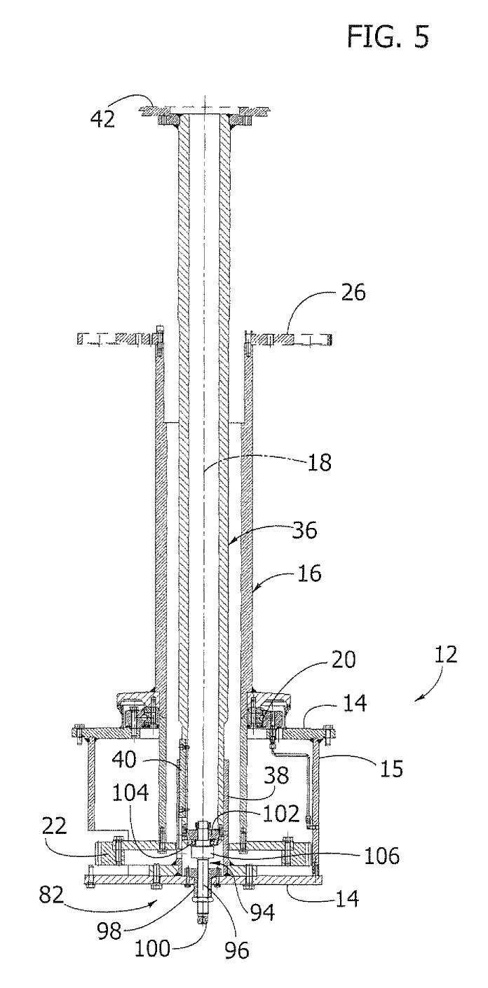

Illustrated in FIG. 5 is a further simplified variant of the adjustment mechanism 82. The items corresponding to the ones described previously are designated by the same reference numbers. In this variant, the adjustment mechanism 82 comprises a pin 94 having a threaded stem 96, which engages a threaded bushing 98 fixed to the bottom horizontal plate 14 of the stationary base 12. The bottom end of the threaded stem 96 has an actuation portion 100 that can be actuated by means of a spanner. The top end of the pin 94 engages in a rotatable way a hole formed in an element 102 fixed to the bottom end of the second shaft 36. A thrust bearing 104 is set between the element 102 and a shoulder 106 of the pin 94. In order to adjust the vertical position of the top supporting plate 42 it is necessary to act by means of a spanner on the actuation portion 100, setting the pin 96 in rotation. Rotation of the pin 96 produces movement in a vertical direction upwards or downwards of the second shaft 36.

Of course, without prejudice to the principle of the invention, the details of construction and the embodiments may vary widely with respect to what is described and illustrated herein, without thereby departing from the scope of the invention as defined in the ensuing claims.

1. A machine for application of threaded caps on containers, comprising:
a bottom stationary base;
a first shaft that extends upwards from the bottom stationary base, the first shaft being rotatable with respect to the base about a vertical axis and being axially fixed in a vertical direction with respect to the base;
a rotary structure fixed to a top end of the first shaft and designed to convey the containers to be capped along a circular path;
a second shaft, which extends upwards from the stationary base, the second shaft being rotationally fixed with respect to the base and being adjustable in a vertical direction with respect to the stationary base, wherein the second shaft extends upwards beyond the top end of the first shaft;
a top supporting plate fixed to the top end of the second shaft bearing a drum cam;
a plurality of screwing heads carried by the rotary structure, each screwing head comprising a vertically mobile support that engages said drum cam and a spindle carried in a rotatable way by the respective vertically mobile support, each spindle bearing at its bottom end an assembly for gripping the caps provided with a movement of screwing; and
an adjustment device, designed to adjust the vertical position of the second shaft with respect to the stationary base.

2. The machine according to claim 1, wherein the adjustment mechanism comprises a third shaft rotatable about said axis of rotation and fixed in a vertical direction with respect to said stationary base, wherein a threaded element is fixed to one end of said third shaft, said threaded element engaging an internal thread fixed to said top supporting plate.

3. The machine according to claim 1, wherein said adjustment mechanism comprises a rotatable pin having a threaded stem that engages an internal thread fixed to said bottom stationary base, said rotatable pin engaging in a rotatable way an element fixed to a bottom end of said second shaft.

4. The machine according to claim 1, wherein the top supporting plate bears a stationary gear, which co-operates with a plurality of gears fixed with respect to said spindles.

5. The machine according to claim 1, wherein the rotary structure comprises at least one top rotary plate fixed to the top end of the first shaft and bearing a plurality of guide bushings engaged in a freely sliding and rotatable way by respective spindles.
